(19) United States
(12) Patent Application Publication
(10) Pub. No.: US 2002/0107315 A1
(43) Pub. Date: Aug. 8, 2002

(54) Halogenated fire-retardant compositions and foams and fabricated articles therefrom.

(76) Inventors: Bharat I. Chaudhary, Pearland, TX (US); Russell P. Barry, Gamshurst (DE); Yunwa W. Cheung, Lake Jackson, TX (US); Thoi H. Ho, Lake Jackson, TX (US); Martin J. Guest, Lake Jackson, TX (US); William G. Stobby, Midland, MI (US)

Correspondence Address: THE DOW CHEMICAL COMPANY, INTELLECTUAL PROPERTY SECTION, 2301 N BRAZOSPORT BLVD, FREEPORT, TX, 77541-3257, US

(21) Appl. No.: 09/728,145

(22) Filed: Dec. 1, 2000

Related U.S. Application Data
(60) Provisional application No. 60/168,844, filed on Dec. 3, 1999.

(51) Int. Cl. C08K 5/06; C08K 3/10

(52) U.S. Cl. 524/371; 524/409

(57) ABSTRACT

The compositions of the present invention comprise at least one substantially random interpolymer (or blends with other thermoplastics), one or more flame retardant compounds and, optionally one or more flame-retardant synergists. For levels of flame retardants which yield a halogen content of about 0.05 to about 50 parts-per-hundred resin (phr), depending on whether the structure is foamed or not, which in turn result in LOI levels greater than or equal to about 23% oxygen, the compositions of the present invention unexpectedly still retain desirable mechanical properties such as compressive strength, toughness, and elasticity.

### CROSS-REFERENCE TO RELATED APPLICATIONS.

This application claims priority from and is a continuation in part of U.S. application Ser. No. 60/168844, filed on Dec. 3, 1999.

### STATEMENT REGARDING FEDERALLY SPONSORED RESEARCH OR DEVELOPMENT

Not Applicable

### BACKGROUND OF THE INVENTION

There are a wide variety of flame-retardants known in the art to increase the fire resistance of various thermoplastics such as polycarbonate, polystyrene and polyolefins (for example, polyethylene and polypropylene). Alumina trihydrate (ATH) is typically used to impart flame retardancy to polyolefins such as polyethylene and polypropylene. However, it must typically be used in high loadings to function effectively. Halogenated flame retardants may be used at relatively low loadings to impart high degrees of flame retardancy, although the unit cost of these products is higher than other classes of flame retardants,. Polybrominated diphenyloxides are the additives of choice for many of the styrenic polymer compositions. Typically when flame retardant additive packages are used in polystyrene or high impact polystyrene (HIPS), a loss in polymer mechanical properties such as toughness and elongation results, often requiring the use of additional toughening agents. Thus, it would be desirable to have compositions comprising substantially random interpolymers, and articles fabricated therefrom, which exhibit good flame retardant properties (i.e., LOI>21%, preferably>23%) and which still retain acceptable physical and mechanical properties, without the requirement of additional toughening agents.

The compositions of the present invention comprise at least one substantially random interpolymer (or blends with other thermoplastics), one or more flame retardant compounds and, optionally one or more flame-retardant synergists. The resulting compositions have enhanced flame retardency, for example having limiting oxygen index (LOI) values greater than 21%, preferably greater than 23% oxygen, but surprisingly retaining desirable mechanical properties such as compressive strength, toughness, and elasticity. The substantially random interpolymers used to prepare the flame retardant compositions of the present invention include interpolymers prepared by polymerizing one or more α-olefins with one or more vinyl or vinylidene aromatic monomers and/or one or more hindered aliphatic or cycloaliphatic vinyl or vinylidene monomers. Control of the interpolymer composition in terms of the comonomer contents, allows the compositions to be used in a wide variety of product applications while requiring only one type of flame retardant additive package. In one embodiment, the compositions are used to prepare foam structures which may be either crosslinked or non-crosslinked.

### BRIEF SUMMARY OF THE INVENTION

The compositions of the present invention comprise at least one substantially random interpolymer (or blends with other thermoplastics), one or more flame retardant compounds and, optionally one or more flame-retardant synergists. For levels of flame retardants which yield a halogen content of about 0.05 to about 50 parts-per-hundred resin (phr), depending on whether the structure is foamed or not, which in turn result in LOI levels greater than or equal to about 23% oxygen, the compositions of the present invention unexpectedly still retain desirable mechanical properties such as compressive strength, toughness, and elasticity.

### DETAILED DESCRIPTION OF THE INVENTION

Definitions

All references herein to elements or metals belonging to a certain Group refer to the Periodic Table of the Elements published and copyrighted by CRC Press, Inc., 1989. Also any reference to the Group or Groups shall be to the Group or Groups as reflected in this Periodic Table of the Elements using the IUPAC system for numbering groups.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

The term “fire retardant” or “flame retardant” is used herein to indicate a flame retardant which can be any halogen-containing compound or mixture of compounds which imparts flame resistance to the compositions of the present invention.

The term “flame retardant synergist” is used herein to indicate inorganic or organic compounds which enhance the effectiveness of flame-retardants, especially halogenated flame retardants.

The term “interpolymer” is used herein to indicate a polymer wherein at least two different monomers are polymerized to make the interpolymer. This includes copolymers, terpolymers, etc.

The term “substantially random” (in the substantially random interpolymer comprising polymer units derived from one or more α-olefin monomers with one or more vinyl or vinylidene aromatic monomers and/or a hindered aliphatic or cycloaliphatic vinyl or vinylidene monomers) as used herein means that the distribution of the monomers of said interpolymer can be described by the Bernoulli statistical model or by a first or second order Markovian statistical model, as described by J. C. Randall in POLYMER SEQUENCE DETERMINATION, Carbon-13 NMR Method, Academic Press New York, 1977, pp. 71-78. Preferably, substantially random interpolymers do not contain more than 15 percent of the total amount of vinyl or vinylidene aromatic monomer in blocks of vinyl or vinylidene aromatic monomer of more than 3 units. More preferably, the interpolymer is not characterized by a high degree of either isotacticity or syndiotacticity. This means that in the carbon⁻¹³ NMR spectrum of the substantially random interpolymer the peak areas corresponding to the main chain methylene and methine carbons representing either meso diad sequences or racemic diad sequences should not exceed 75 percent of the total peak area of the main chain methylene and methine carbons.

Suitable α-olefins include for example, α-olefins containing from 2 to about 20, preferably from 2 to about 12, more preferably from 2 to about 8 carbon atoms. Particularly suitable are ethylene, propylene, butene-1, pentene-1, 4-methyl-1-pentene, hexene-1 or octene-1 or ethylene in combination with one or more of propylene, butene-1, 4-methyl-1-pentene, hexene-1 or octene-1. These α-olefins do not contain an aromatic moiety.

Suitable vinyl or vinylidene aromatic monomers which can be employed to prepare the interpolymers include, for example, those represented by the following formula:

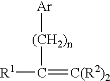

wherein R¹ is selected from the group of radicals consisting of hydrogen and alkyl radicals containing from 1 to about 4 carbon atoms, preferably hydrogen or methyl; each R² is independently selected from the group of radicals consisting of hydrogen and alkyl radicals containing from 1 to about 4 carbon atoms, preferably hydrogen or methyl; Ar is a phenyl group or a phenyl group substituted with from 1 to 5 substituents selected from the group consisting of halo, C₁₋₄-alkyl, and C₁₋₄-haloalkyl; and n has a value from zero to about 4, preferably from zero to 2, most preferably zero. Exemplary vinyl or vinylidene aromatic monomers include styrene, vinyl toluene, α-methylstyrene, t-butyl styrene, chlorostyrene, including all isomers of these compounds, and the like. Particularly suitable such monomers include styrene and lower alkyl- or halogen-substituted derivatives thereof. Preferred monomers include styrene, α-methyl styrene, the lower alkyl-(C₁-C₄) or phenyl-ring substituted derivatives of styrene, such as for example, ortho-, meta-, and para-methylstyrene, the ring halogenated styrenes, para-vinyl toluene or mixtures thereof, and the like. A more preferred aromatic vinyl monomer is styrene.

By the term “hindered aliphatic or cycloaliphatic vinyl or vinylidene compounds”, it is meant addition polymerizable vinyl or vinylidene monomers corresponding to the formula:

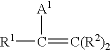

wherein A¹ is a sterically bulky, aliphatic or cycloaliphatic substituent of up to 20 carbons, R¹ is selected from the group of radicals consisting of hydrogen and alkyl radicals containing from 1 to about 4 carbon atoms, preferably hydrogen or methyl; each R² is independently selected from the group of radicals consisting of hydrogen and alkyl radicals containing from 1 to about 4 carbon atoms, preferably hydrogen or methyl; or alternatively R¹ and A¹ together form a ring system. By the term “sterically bulky” is meant that the monomer bearing this substituent is normally incapable of addition polymerization by standard Ziegler-Natta polymerization catalysts at a rate comparable with ethylene polymerizations. Simple linera higher aliphatic alpha olefins such as propylene, 1-butene 1-hexene, 1-octene and the like are not examples of hindered aliphatic or cycloaliphatic vinyl or vinylidene compounds. Preferred hindered aliphatic or cycloaliphatic vinyl or vinylidene compounds are monomers in which one of the carbon atoms bearing ethylenic unsaturation is tertiary or quaternary substituted. Examples of such substituents include cyclic aliphatic groups such as cyclohexyl, cyclohexenyl, cyclooctenyl, or ring alkyl or aryl substituted derivatives thereof, tert-butyl, norbornyl, and the like. Most preferred hindered aliphatic or cycloaliphatic vinyl or vinylidene compounds are the various isomeric vinyl-ring substituted derivatives of cyclohexene and substituted cyclohexenes, and 5-ethylidene-2-norbornene. Especially suitable are 1-, 3-, and 4-vinylcyclohexene.

Other optional polymerizable ethylenically unsaturated monomer(s) include norbornene and C₁₋₁₀ alkyl or C₆₋₁₀ aryl substituted norbornenes. Exemplary substantially random interpolymers include ethylene/styrene, ethylene/styrene/propylene, ethylene/styrene/octene, ethylene/styrene/butene, and ethylene/styrene/norbornene interpolymers.

The substantially random interpolymers may be modified by typical grafting, hydrogenation, functionalizing, or other reactions well known to those skilled in the art. The polymers may be readily sulfonated or chlorinated to provide functionalized derivatives according to established techniques.

The substantially random interpolymers may also be modified by various cross-linking processes including, but not limited to peroxide-, silane-, sulfur-, radiation-, or azide-based cure systems. A full description of the various cross-linking technologies is described in copending U.S. patent application Ser. Nos. 08/921,641 and 08/921,642 both filed on Aug. 27, 1997, the entire contents of both of which are herein incorporated by reference.

Dual cure systems, which use a combination of heat, moisture cure, and radiation steps, may be effectively employed. Dual cure systems are disclosed and claimed in U.S. patent application Ser. No. 536,022, filed on Sep. 29, 1995, in the names of K. L. Walton and S. V. Karande, incorporated herein by reference. For instance, it may be desirable to employ peroxide crosslinking agents in conjunction with silane crosslinking agents, peroxide crosslinking agents in conjunction with radiation, sulfur-containing crosslinking agents in conjunction with silane crosslinking agents, etc.

The substantially random interpolymers may also be modified by various cross-linking processes including, but not limited to the incorporation of a diene component as a termonomer in its preparation and subsequent cross linking by the aforementioned methods and further methods including vulcanization via the vinyl group using sulfur for example as the cross linking agent.

One method of preparation of the substantially random interpolymers includes polymerizing a mixture of polymerizable monomers in the presence of one or more metallocene or constrained geometry catalysts in combination with various cocatalysts.

The substantially random interpolymers include the pseudo-random interpolymers as described in EP-A-0,416,815 by James C. Stevens et al. and U.S. Pat. No. 5,703,187 by Francis J. Timmers, both of which are incorporated herein by reference in their entirety. The substantially random interpolymers also include the substantially random terpolymers as described in U.S. Pat. No. 5,872,201 which is incorporated herein by reference in their entirety. The substantially random interpolymers can be prepared by polymerizing a mixture of polymerizable monomers in the presence of one or more metallocene or constrained geometry catalysts in combination with various cocatalysts. Preferred operating conditions for the polymerization reactions are pressures from atmospheric up to 3000 atmospheres and temperatures from −30° C. to 200° C. Polymerizations and unreacted monomer removal at temperatures above the autopolymerization temperature of the respective monomers may result in formation of some amounts of homopolymer polymerization products resulting from free radical polymerization.

Examples of suitable catalysts and methods for preparing the substantially random interpolymers are disclosed in U.S. application Ser. No. 545,403, filed Jul. 3, 1990 (EP-A-416,815); U.S. application Ser. No. 702,475, filed May 20, 1991 (EP-A-514,828); U.S. application Ser. No. 876,268, filed May 1, 1992, (EP-A-520,732); U.S. application Ser. No. 241,523, filed May 12, 1994; as well as U.S. Pat. Nos. 5,055,438; 5,057,475; 5,096,867; 5,064,802; 5,132,380; 5,189,192; 5,321,106; 5,347,024; 5,350,723; 5,374,696; and 5,399,635 all of which patents and applications are incorporated herein by reference.

The substantially random α-olefin/vinyl or vinylidene aromatic interpolymers can also be prepared by the methods described in JP 07/278230 employing compounds shown by the general formula

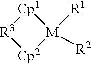

where Cp¹ and Cp² are cyclopentadienyl groups, indenyl groups, fluorenyl groups, or substituents of these, independently of each other; R¹ and R² are hydrogen atoms, halogen atoms, hydrocarbon groups with carbon numbers of 1-12, alkoxyl groups, or aryloxyl groups, independently of each other; M is a group IV metal, preferably Zr or Hf, most preferably Zr; and R³ is an alkylene group or silanediyl group used to cross-link Cp¹ and Cp²).

The substantially random α-olefin/vinyl or vinylidene aromatic interpolymers can also be prepared by the methods described by John G. Bradfute et al. (W. R. Grace & Co.) in WO 95/32095; by R. B. Pannell (Exxon Chemical Patents, Inc.) in WO 94/00500; and in Plastics Technology, p. 25 (September 1992), all of which are incorporated herein by reference in their entirety.

Also suitable are the substantially random interpolymers which comprise at least one α-olefin/vinyl aromatic/vinyl aromatic/α-olefin tetrad disclosed in U.S. application Ser. No. 08/708,809 filed Sep. 4, 1996 by Francis J. Timmers et al. These interpolymers contain additional signals with intensities greater than three times the peak to peak noise. These signals appear in the chemical shift range 43.70-44.25 ppm and 38.0-38.5 ppm. Specifically, major peaks are observed at 44.1, 43.9 and 38.2 ppm. A proton test NMR experiment indicates that the signals in the chemical shift region 43.70-44.25 ppm are methine carbons and the signals in the region 38.0-38.5 ppm are methylene carbons.

It is believed that these new signals are due to sequences involving two head-to-tail vinyl aromatic monomer insertions preceded and followed by at least one α-olefin insertion, e.g. an ethylene/styrene/styrene/ethylene tetrad wherein the styrene monomer insertions of said tetrads occur exclusively in a 1,2 (head to tail) manner. It is understood by one skilled in the art that, for such tetrads involving a vinyl aromatic monomer other than styrene and an α-olefin other than ethylene, that the ethylene/vinyl aromatic monomer/vinyl aromatic monomer/ethylene tetrad will give rise to similar carbon⁻¹³ NMR peaks but with slightly different chemical shifts.

These interpolymers are prepared by conducting the polymerization at temperatures of from about −30° C. to about 250° C. in the presence of such catalysts as those represented by the formula

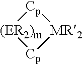

wherein: each Cp is independently, each occurrence, a substituted cyclopentadienyl group π-bound to M; E is C or Si; M is a group IV metal, preferably Zr or Hf, most preferably Zr; each R is independently, each occurrence, H, hydrocarbyl, silahydrocarbyl, or hydrocarbylsilyl, containing up to about 30 preferably from 1 to about 20 more preferably from 1 to about 10 carbon or silicon atoms; each R′ is independently, each occurrence, H, halo, hydrocarbyl, hyrocarbyloxy, silahydrocarbyl, hydrocarbylsilyl containing up to about 30 preferably from 1 to about 20 more preferably from 1 to about 10 carbon or silicon atoms or two R′ groups together can be a C₁₋₁₀ hydrocarbyl substituted 1,3-butadiene; m is 1 or 2; and optionally, but preferably in the presence of an activating cocatalyst. Particularly, suitable substituted cyclopentadienyl groups include those illustrated by the formula:

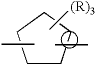

wherein each R is independently, each occurrence, H, hydrocarbyl, silahydrocarbyl, or hydrocarbylsilyl, containing up to about 30 preferably from 1 to about 20 more preferably from 1 to about 10 carbon or silicon atoms or two R groups together form a divalent derivative of such group. Preferably, R independently each occurrence is (including where appropriate all isomers) hydrogen, methyl, ethyl, propyl, butyl, pentyl, hexyl, benzyl, phenyl or silyl or (where appropriate) two such R groups are linked together forming a fused ring system such as indenyl, fluorenyl, tetrahydroindenyl, tetrahydrofluorenyl, or octahydrofluorenyl.

Particularly preferred catalysts include, for example, racemic-(dimethylsilanediyl)-bis-(2-methyl-4-phenylindenyl)zirconium dichloride, racemic-(dimethylsilanediyl)-bis-(2-methyl-4-phenylindenyl)zirconium 1,4-diphenyl-1, 3-butadiene, racemic-(dimethylsilanediyl)-bis-(2-methyl-4-phenylindenyl)zirconium di-C₁₋₄ alkyl, racemic-(dimethylsilanediyl)-bis-(2-methyl-4-phenylindenyl)zirconium di-C₁₋₄ alkoxide, or any combination thereof and the like. Also included are the titanium-based catalysts, [N-(1,1-dimethylethyl)-1,1-dimethyl-1-[(1,2,3,4,5-η)-1, 5,6,7-tetrahydro-s-indacen-1-yl]silanaminato(2-)-N]titanium dimethyl; (1-indenyl)(tert-butylamido)dimethyl-silane titanium dimethyl; ((3-tert-butyl)(1,2,3,4,5-η)-1-indenyl)(tert-butylamido) dimethylsilane titanium dimethyl; and ((3-isopropyl)(1,2,3,4,5-η)-1-indenyl)(tert-butyl amido)dimethylsilane titanium dimethyl, or any combination thereof and the like.

Further preparative methods for the interpolymers used in the present invention have been described in the literature. Longo and Grassi (Makromol. Chem., Volume 191, pages 2387 to 2396 [1990]) and D'Anniello et al. (Journal of Applied Polymer Science, Volume 58, pages 1701-1706 [1995]) reported the use of a catalytic system based on methylalumoxane (MAO) and cyclopentadienyltitanium trichloride (CpTiCl₃) to prepare an ethylene-styrene copolymer. Xu and Lin (Polymer Preprints, Am. Chem. Soc., Div. Polym. Chem.) Volume 35, pages 686,687 [1994]) have reported copolymerization using a MgCl₂/TiCl₄/NdCl₃/Al(iBu)₃ catalyst to give random copolymers of styrene and propylene. Lu et al (Journal of Applied Polymer Science, Volume 53, pages 1453 to 1460 [1994]) have described the copolymerization of ethylene and styrene using a TiCl₄/NdCl₃/MgCl₂/Al(Et)₃ catalyst. Sernetz and Mulhaupt, (Macromol. Chem. Phys., v. 197, pp. 1071-1083, 1997) have described the influence of polymerization conditions on the copolymerization of styrene with ethylene using Me₂Si(Me₄Cp)(N-tert-butyl)TiCl₂/methylaluminoxane Ziegler-Natta catalysts. Copolymers of ethylene and styrene produced by bridged metallocene catalysts have been described by Arai, Toshiaki and Suzuki (Polymer Preprints, Am. Chem. Soc., Div. Polym. Chem.) Volume 38, pages 349, 350 [1997]) and in U.S. Pat. No. 5,652,315, issued to Mitsui Toatsu Chemicals, Inc. The manufacture of α-olefin/vinyl aromatic monomer interpolymers such as propylene/styrene and butene/styrene are described in U.S. Pat. No. 5,244,996, issued to Mitsui Petrochemical Industries Ltd or U.S. Pat. No. 5,652,315 also issued to Mitsui Petrochemical Industries Ltd or as disclosed in DE 197 11 339 A1 nad U.S. Pat. No. 5,883,213 to Denki Kagaku Kogyo K K. All the above methods disclosed for preparing the interpolymer component are incorporated herein by reference. Also, although of high isotacticity, the random copolymers of ethylene and styrene as disclosed in Polymer Preprints Vol 39, No. 1, March 1998 by Toru Aria et al. can also be employed as components of the present invention.

The interpolymers of ethylene and/or one or more α-olefins and one or more vinyl or vinylidene aromatic monomers and/or one or more hindered aliphatic or cycloaliphatic vinyl or vinylidene monomers employed in the present invention are substantially random polymers. These interpolymers usually contain from about 0.5 to about 65, preferably from about 1 to about 55, more preferably from about 1 to about 50 mole percent of at least one vinyl or vinylidene aromatic monomer and/or hindered aliphatic or cycloaliphatic vinyl or vinylidene monomer and from about 35 to about 99.5, preferably from about 45 to about 99, more preferably from about 50 to about 99 mole percent of ethylene and/or at least one aliphatic α-olefin having from 3 to about 20 carbon atoms.

The interpolymer(s) applicable to the present invention can have a melt index (I₂) of greater than about 0.001, preferably from about 0.1 to about 200, more preferably of from about 0.5 to about 100 g/10 min.

While preparing the substantially random interpolymer, an amount of atactic vinyl or vinylidene aromatic homopolymer may be formed due to homopolymerization of the vinyl or vinylidene aromatic monomer at elevated temperatures. The presence of vinyl or vinylidene aromatic homopolymer is in general not detrimental for the purposes of the present invention and can be tolerated. The vinyl or vinylidene aromatic homopolymer may be separated from the interpolymer, if desired, by extraction techniques such as selective precipitation from solution with a non solvent for either the interpolymer or the vinyl or vinylidene aromatic homopolymer. For the purpose of the present invention it is preferred that no more than 20 weight percent, preferably less than 15 weight percent based on the total weight of the interpolymers of atactic vinyl or vinylidene aromatic homopolymer is present.

The compositions and fabricated articles of the present invention will comprise one or more substantially random interpolymers and, optionally, one or more other thermoplastics that may be blended with the substantially random interpolymers. The other thermoplastics include, but are not limited to, the α-olefin homopolymers and interpolymers, the thermoplastic olefins (TPOs), the styrene-diene copolymers, the styrenic copolymers, the elastomers, the thermoset polymers, the vinyl halide polymers, and the engineering thermoplastics.

The α-Olefin Homopolymers and Interpolymers

The α-olefin homopolymers and interpolymers comprise polypropylene, propylene/C₄-C₂₀ α-olefin copolymers, polyethylene, and ethylene/C₃-C₂₀ α-olefin copolymers, the interpolymers can be either heterogeneous ethylene/α-olefin interpolymers or homogeneous ethylene/α-olefin interpolymers, including the substantially linear ethylene/α-olefin interpolymers. Also included are aliphatic α-olefins having from 2 to 20 carbon atoms and containing polar groups.

Also included in this group are olefinic monomers which introduce polar groups into the polymer include, for example, ethylenically unsaturated nitriles such as acrylonitrile, methacrylonitrile, ethacrylonitrile, etc.; ethylenically unsaturated anhydrides such as maleic anhydride; ethylenically unsaturated amides such as acrylamide, methacrylamide etc.; ethylenically unsaturated carboxylic acids (both mono- and difunctional) such as acrylic acid and methacrylic acid, etc.; esters (especially lower, e.g. C₁-C₆, alkyl esters) of ethylenically unsaturated carboxylic acids such as methyl methacrylate, ethyl acrylate, hydroxyethylacrylate, n-butyl acrylate or methacrylate, 2-ethyl-hexylacrylate, or ethylene-vinyl acetate copolymers (EVA) etc.; ethylenically unsaturated dicarboxylic acid imides such as N-alkyl or N-aryl maleimides such as N-phenyl maleimide, etc. Preferably such monomers containing polar groups are EVA, acrylic acid, vinyl acetate, maleic anhydride and acrylonitrile.

Heterogeneous interpolymers are differentiated from the homogeneous interpolymers in that in the latter, substantially all of the interpolymer molecules have the same ethylene/comonomer ratio within that interpolymer, whereas heterogeneous interpolymers are those in which the interpolymer molecules do not have the same ethylene/comonomer ratio. The term “broad composition distribution” used herein describes the comonomer distribution for heterogeneous interpolymers and means that the heterogeneous interpolymers have a “linear” fraction and that the heterogeneous interpolymers have multiple melting peaks (i.e., exhibit at least two distinct melting peaks) by DSC. The heterogeneous interpolymers have a degree of branching less than or equal to 2 methyls/1000 carbons in about 10 percent (by weight) or more, preferably more than about 15 percent (by weight), and especially more than about 20 percent (by weight). The heterogeneous interpolymers also have a degree of branching equal to or greater than 25 methyls/1000 carbons in about 25 percent or less (by weight), preferably less than about 15 percent (by weight), and especially less than about 10 percent (by weight).

The Ziegler catalysts suitable for the preparation of the heterogeneous component of the current invention are typical supported, Ziegler-type catalysts. Examples of such compositions are those derived from organomagnesium compounds, alkyl halides or aluminum halides or hydrogen chloride, and a transition metal compound. Examples of such catalysts are described in U.S. Pat. Nos. 4,314,912 (Lowery, Jr. et al.), 4,547,475 (Glass et al.), and 4,612,300 (Coleman, III), the teachings of which are incorporated herein by reference.

Suitable catalyst materials may also be derived from a inert oxide supports and transition metal compounds. Examples of such compositions are described in U.S. Pat. No. 5,420,090 (Spencer. et al.), the teachings of which are incorporated herein by reference.

The heterogeneous polymer component can be a homolymer of ethylene or an α-olefin preferably polyethylene or polypropylene, or, preferably, an interpolymer of ethylene with at least one C₃-C₂₀ α-olefin and/or C₄-C₁₈ dienes. Heterogeneous copolymers of ethylene, and propylene, 1-butene, 1-hexene, 4-methyl-1-pentene and 1-octene are especially preferred.

The relatively recent introduction of metallocene-based catalysts for ethylene/α-olefin polymerization has resulted in the production of new ethylene interpolymers known as homogeneous interpolymers.

The homogeneous interpolymers useful for forming the compositions described herein have homogeneous branching distributions. That is, the polymers are those in which the comonomer is randomly distributed within a given interpolymer molecule and wherein substantially all of the interpolymer molecules have the same ethylene/comonomer ratio within that interpolymer. The homogeneity of the polymers is typically described by the SCBDI (Short Chain Branch Distribution Index) or CDBI (Composition Distribution Branch Index) and is defined as the weight percent of the polymer molecules having a comonomer content within 50 percent of the median total molar comonomer content. The CDBI of a polymer is readily calculated from data obtained from techniques known in the art, such as, for example, temperature rising elution fractionation (abbreviated herein as “TREF”) as described, for example, in Wild et al, Journal of Polymer Science, Poly. Phys. Ed., Vol. 20, p. 441 (1982), in U.S. Pat. No. 4,798,081 (Hazlitt et al.), or as is described in U.S. Pat. No. 5,008,204 (Stehling), the disclosure of which is incorporated herein by reference. The technique for calculating CDBI is described in U.S. Pat. No. 5,322,728 (Davey et al. ) and in U.S. Pat. No. 5,246,783 (Spenadel et al.). or in U.S. Pat. No. 5,089,321 (Chum et al.) the disclosures of all of which are incorporated herein by reference. The SCBDI or CDBI for the homogeneous interpolymers used in the present invention is preferably greater than about 30 percent, especially greater than about 50 percent.

The homogeneous interpolymers used in this invention essentially lack a measurable “high density” fraction as measured by the TREF technique (i.e., the homogeneous ethylene/α-olefin interpolymers do not contain a polymer fraction with a degree of branching less than or equal to 2 methyls/1000 carbons). The homogeneous interpolymers also do not contain any highly short chain branched fraction (i.e., they do not contain a polymer fraction with a degree of branching equal to or more than 30 methyls/1000 carbons).

The substantially linear ethylene/α-olefin polymers and interpolymers blend components of the present invention are also homogeneous interpolymers but are further herein defined as in U.S. Pat. No. 5,272,236 (Lai et al.), and in U.S. Pat. No. 5,272,872, the entire contents of which are incorporated by reference. Such polymers are unique however due to their excellent processability and unique rheological properties and high melt elasticity and resistance to melt fracture. These polymers can be successfully prepared in a continuous polymerization process using the constrained geometry metallocene catalyst systems.

The term “substantially linear” ethylene/α-olefin interpolymer means that the polymer backbone is substituted with about 0.01 long chain branches/1000 carbons to about 3 long chain branches/1000 carbons, more preferably from about 0.01 long chain branches/1000 carbons to about 1 long chain branches/1000 carbons, and especially from about 0.05 long chain branches/1000 carbons to about 1 long chain branches/1000 carbons.

Long chain branching is defined herein as a chain length of at least one carbon more than two carbons less than the total number of carbons in the comonomer, for example, the long chain branch of an ethylene/octene substantially linear ethylene interpolymer is at least seven (7) carbons in length (i.e., 8 carbons less 2 equals 6 carbons plus one equals seven carbons long chain branch length). The long chain branch can be as long as about the same length as the length of the polymer back-bone. Long chain branching is determined by using ¹³C nuclear magnetic resonance (NMR) spectroscopy and is quantified using the method of Randall (Rev. Macromol. Chem. Phys., C29 (2&3), p. 285-297), the disclosure of which is incorporated herein by reference. Long chain branching, of course, is to be distinguished from short chain branches which result solely from incorporation of the comonomer, so for example the short chain branch of an ethylene/octene substantially linear polymer is six carbons in length, while the long chain branch for that same polymer is at least seven carbons in length.

The catalysts used to prepare the homogeneous interpolymers for use as blend components in the present invention are metallocene catalysts. These metallocene catalysts include the bis(cyclopentadienyl)-catalyst systems and the mono(cyclopentadienyl) Constrained Geometry catalyst systems (used to prepare the substantially linear ethylene/(α-olefin polymers). Such constrained geometry metal complexes and methods for their preparation are disclosed in U.S. application Ser. No. 545,403, filed Jul. 3, 1990 (EP-A-416,815); U.S. application Ser. No. 547,718, filed Jul. 3, 1990 (EP-A-468,65 1); U.S. application Ser. No. 702,475, filed May 20, 1991 (EP-A-514,828); as well as U.S. Pat. No. 5,055,438, U.S. Pat. No. 5,057,475, U.S. Pat. No. 5,096,867, U.S. Pat. No. 5,064,802, U.S. Pat. No. 5,132,380, U.S. Pat. No. 5,721,185, U.S. Pat. No. 5,374,696 and U.S. Pat. No. 5,470,993. For the teachings contained therein, the aforementioned pending United States patent applications, issued United States patents and published European Patent Applications are herein incorporated in their entirety by reference thereto.

In EP-A 418,044, published Mar. 20, 1991 (equivalent to U.S. Ser. No. 07/758,654) and in U.S. Ser. No. 07/758,660 certain cationic derivatives of the foregoing constrained geometry catalysts that are highly useful as olefin polymerization catalysts are disclosed and claimed. In U.S. Ser. No. 720,041, filed Jun. 24, 1991, certain reaction products of the foregoing constrained geometry catalysts with various boranes are disclosed and a method for their preparation taught and claimed. In U.S. Pat. No. 5,453,410 combinations of cationic constrained geometry catalysts with an alumoxane were disclosed as suitable olefin polymerization catalysts. For the teachings contained therein, the aforementioned pending U.S. patent applications, issued United States patents and published European Patent Applications are herein incorporated in their entirety by reference thereto.

The homogeneous polymer component can be an ethylene or α-olefin homopolymer preferably polyethylene or polypropylene, or, preferably, an interpolymer of ethylene with at least one C₃-C₂₀ a-olefin and/or C₄-C₁₈ dienes. Homogeneous copolymers of ethylene, and propylene, 1-butene, 1-hexene, 4-methyl-1-pentene and 1-octene are especially preferred.

2) Thermoplastic Olefins

Thermoplastic olefins (TPOs) are generally produced from blends of an elastomeric material such as ethylene/propylene rubber (EPM) or ethylene/propylene diene monomer terpolymer (EPDM) and a more rigid material such as isotactic polypropylene. Other materials or components can be added into the formulation depending upon the application, including oil, fillers, and cross-linking agents. Generally, TPOs are characterized by a balance of stiffness (modulus) and low temperature impact, good chemical resistance and broad use temperatures. Because of features such as these, TPOs are used in many applications, including automotive facia and instrument panels, and also potentially in wire and cable

The polypropylene is generally in the isotactic form of homopolymer polypropylene, although other forms of polypropylene can also be used (e.g., syndiotactic or atactic). Polypropylene impact copolymers (e.g., those wherein a secondary copolymerization step reacting ethylene with the propylene is employed) and random copolymers (also reactor modified and usually containing 1.5-7% ethylene copolymerized with the propylene), however, can also be used in the TPO formulations disclosed herein. In-reactor TPO's can also be used as blend components of the present invention. A complete discussion of various polypropylene polymers is contained in Modern Plastics Encyclopedia/89, mid October 1988 Issue, Volume 65, Number 11, pp. 86-92, the entire disclosure of which is incorporated herein by reference. The molecular weight of the polypropylene for use in the present invention is conveniently indicated using a melt flow measurement according to ASTM D-1238, Condition 230° C./2.16 kg (formerly known as “Condition (L)” and also known as I₂). Melt flow rate is inversely proportional to the molecular weight of the polymer. Thus, the higher the molecular weight, the lower the melt flow rate, although the relationship is not linear. The melt flow rate for the polypropylene useful herein is generally from about 0.1 grams/10 minutes (g/10 min) to about 35 g/10 min, preferably from about 0.5 g/10 min to about 25 g/10 min, and especially from about 1 g/10 min to about 20 g/10 min.

3) Styrene-Diene Copolymers

Also included are block copolymers having unsaturated rubber monomer units includes, but is not limited to, styrene-butadiene (SB), styrene-isoprene(SI), styrene-butadiene-styrene (SBS), styrene-isoprene-styrene (SIS), α-methylstyrene-butadiene-α-methylstyrene and α-methylstyrene-isoprene-α-methylstyrene.

The styrenic portion of the block copolymer is preferably a polymer or interpolymer of styrene and its analogs and homologs including α-methylstyrene and ring-substituted styrenes, particularly ring-methylated styrenes. The preferred styrenics are styrene and α-methylstyrene, and styrene is particularly preferred.

Block copolymers with unsaturated rubber monomer units may comprise homopolymers of butadiene or isoprene or they may comprise copolymers of one or both of these two dienes with a minor amount of styrenic monomer.

Preferred block copolymers with saturated rubber monomer units comprise at least one segment of a styrenic unit and at least one segment of an ethylene-butene or ethylene-propylene copolymer. Preferred examples of such block copolymers with saturated rubber monomer units include styrene/ethylene-butene copolymers, styrene/ethylene-propylene copolymers, styrene/ethylene-butene/styrene (SEBS) copolymers, styrene/ethylene-propylene/styrene (SEPS) copolymers.

Also included are random copolymers having unsaturated rubber monomer units includes, but is not limited to, styrene-butadiene (SB), styrene-isoprene(SI), α-methylstyrene-styrene-butadiene, (α-methylstyrene-styrene-isoprene, and styrene-vinyl-pyridine-butadiene.

4) Styrenic Copolymers

In addition to the block and random styrene copolymers are the acrylonitrile-butadiene-styrene (ABS) polymers, styrene-acrylonitrile (SAN), rubber modified styrenics such as high impact polystyrene,

5) Elastomers

The elastomers include but are not limited to rubbers such as polyisoprene, polybutadiene, natural rubbers, ethylene/propylene rubbers, ethylene/propylene diene (EPDM) rubbers, thermoplastic polyurethanes, silicone rubbers, and

6) Thermoset Polymers

The thermoset polymers include but are not limited to epoxies, vinyl ester resins, polyurethanes, phenolics and the like.

7) Vinyl Halide Polymers.

Vinyl halide homopolymers and copolymers are a group of resins which use as a building block the vinyl structure CH₂=CXY, where X is selected from the group consisting of F, Cl, Br, and I and Y is selected from the group consisting of F, Cl, Br, I and H.

The vinyl halide polymer component of the blends of the present invention include but are not limited to homopolymers and copolymers of vinyl halides with copolymerizable monomers such as α-olefins including but not limited to ethylene, propylene, vinyl esters of organic acids containing 1 to 18 carbon atoms, e.g. vinyl acetate, vinyl stearate and so forth; vinyl chloride, vinylidene chloride, symmetrical dichloroethylene; acrylonitrile, methacrylonitrile; alkyl acrylate esters in which the alkyl group contains 1 to 8 carbon atoms, e.g. methyl acrylate and butyl acrylate; the corresponding alkyl methacrylate esters; dialkyl esters of dibasic organic acids in which the alkyl groups contain 1-8 carbon atoms, e.g. dibutyl fumarate, diethyl maleate, and so forth.

Preferably the vinyl halide polymers are homopolymers or copolymers of vinyl chloride or vinylidene dichloride. Poly (vinyl chloride) polymers (PVC) can be further classified into two main types by their degree of rigidity. These are “rigid” PVC and “flexible” PVC. Flexible PVC is distinguished from rigid PVC primarily by the presence of and amount of plasticizers in the resin. Flexible PVC typically has improved processability, lower tensile strength and higher elongation than rigid PVC.

Of the vinylidene chloride homopolymers and copolymers (PVDC), typically the copolymers with vinyl chloride, acrylates or nitriles are used commercially and are most preferred. The choice of the comonomer significantly affects the properties of the resulting polymer. Perhaps the most notable properties of the various PVDC's are their low permeability to gases and liquids, barrier properties; and chemical resistance.

Also included are the various PVC and PVCD formulations containing minor amounts of other materials present to modify the properties of the PVC or PVCD, including but not limited to polystyrene, styrenic copolymers, polyolefins including homo and copolymers comprising polyethylene, and or polypropylene, and other ethylene/α-olefin copolymers, polyacrylic resins, butadiene-containing polymers such as acrylonitrile butadiene styrene terpolymers (ABS), and methacrylate butadiene styrene terpolymers (MBS), and chlorinated polyethylene (CPE) resins and the like.

Also included in the family of vinyl halide polymers for use as blend components of the present invention are the chlorinated derivatives of PVC typically prepared by post chlorination of the base resin and known as chlorinated PVC, (CPVC). Although CPVC is based on PVC and shares some of its characteristic properties, CPVC is a unique polymer having a much higher melt temperature range (410-450° C.) and a higher glass transition temperature (239-275° F.) than PVC.

8) Engineering Thermoplastics

Engineering thermoplastics include but are not limited to poly(methylmethacrylate) (PMMA), nylons, poly(acetals), polystyrene (atactic and syndiotactic), polycarbonate, thermoplastic polyurethanes, polysiloxane, polyphenylene oxide (PPO), and aromatic polyesters.

The loadings of substantially random interpolymers will be from about 0.5 to about 100, preferably from about 1 to about 100, and most preferably from about 2 to about 100 percent by weight of the polymer composition.

Flame Retardant

Suitable flame retardants are well-known in the art and include but are not limited to hexahalodiphenyl ethers, octahalodiphenyl ethers, decahalodiphenyl ethers, decahalobiphenyl ethanes, 1,2-bis(trihalophenoxy)ethanes, 1,2-bis(pentahalophenoxy)ethanes, hexahalocyclododecane, a tetrahalobisphenol-A, ethylene(N, N′)-bis-tetrahalophthalimides, tetrahalophthalic anhydrides, hexahalobenzenes, halogenated indanes, halogenated phosphate esters, halogenated paraffins, halogenated polystyrenes, and polymers of halogenated bisphenol-A and epichlorohydrin, or mixtures thereof. Preferably, the flame retardant is a bromine or chlorine containing compound. The halogenated fire-retardants may include one or more of hexabromocycledodecane (HBCD), tetrabromobisphenol-A (TBBA), chlorowax and may be used with or without flame retardant synergists. A number of fire-retardants are disclosed in U.S. Pat. No. 5,171,757, the entire contents of which are herein incorporated by reference. For structures that are not foamed, the halogen content in the final structures will typically be 0.5-50 wt %, preferably 1-40 wt % and most preferably 1.5-30 wt %. For foams, the halogen content in the final structures should be 0.05-20 wt %, preferably 0.1-15 wt % and most preferably 0.2-10 wt %.

In a preferred embodiment, the flame retardant is a hexahalocyclododecane, preferably hexabromocyclododecane (HBCD) or a combination with any other halogenated or non-halogenated flame-retardants, which can include, but are not limited to phosphorous based flame retardants such as triphenyl phosphate and encapsulated red phosphorous.

Flame Retardant Synergist

Examples of inorganic flame retardant synergists include, but are not limited to, metal oxides, e.g. iron oxide, tin oxide, zinc oxide, aluminum trioxide, alumina, antimony tri- and pentoxide, bismuth oxide, molybdenum trioxide, and tungsten trioxide, boron compounds such as zinc borate, antimony silicates, zinc stannate, zinc hydroxystannate, ferrocene and mixtures thereof. Examples of organic flame retardant synergists include, but are not limited to dicumyl and polycumyl.

Additives

Additives such as antioxidants (e.g., hindered phenols such as, for example, Irganox® 1010), phosphites (e.g., Irgafos® 168), ) both commercially available from Ciba Geigy corporation), U.V. Stabilizers, cling additives (e.g., polyisobutylene), antiblock additives, colorants, pigments, fillers, acid scavengers (including, but not limited to, zeolite, organic carboxylates and hydrotalcite) and the like can optionally also be included in the compositions and fabricated articles of the present invention, to the extent that they do not interfere with their enhanced properties.

The additives are advantageously employed in functionally equivalent amounts known to those skilled in the art. For example, the amount of antioxidant employed is that amount which prevents the polymer or polymer blend from undergoing oxidation at the temperatures and environment employed during storage and ultimate use of the polymers. Such amount of antioxidants is usually in the range of from 0.01 to 10, preferably from 0.05 to 5, more preferably from 0.1 to 2 percent by weight based upon the weight of the polymer or polymer blend. Similarly, the amounts of any of the other enumerated additives are the functionally equivalent amounts such as the amount to render the polymer or polymer blend antiblocking, to produce the desired amount of filler loading to produce the desired result, to provide the desired color from the colorant or pigment. Such additives are advantageously employed in the range of from 0.05 to 50, preferably from 0.1 to 35, more preferably from 0.2 to 20 percent by weight based upon the weight of the polymer or polymer blend.

Preferred examples of fillers are talc, carbon black, carbon fibers, calcium carbonate, alumina trihydrate, glass fibers, marble dust, cement dust, clay, feldspar, silica or glass, fumed silica, alumina, magnesium oxide, magnesium hydroxide, antimony oxide, zinc oxide, barium sulfate, aluminum silicate, calcium silicate, titanium dioxide, titanates, glass microspheres or chalk. Of these fillers, barium sulfate, talc, calcium carbonate, silica/glass, glass fibers, alumina and titanium dioxide, and mixtures thereof are preferred. The most preferred inorganic fillers are talc, calcium carbonate, barium sulfate, glass fibers or mixtures thereof. These fillers could be employed in amounts from 0 to about 90, preferably from 0 to about 80, more preferably from 0 to about 70% by weight based on the weight of the polymer or polymer blend.

One type of additive found useful in the polymer compositions used to prepare the fabricated articles of the present invention are lubricating agents. Such additives are better known by a variety of more common names such as slip agent or release agent which seem to depend upon the particular property modification contemplated for the additive. Illustrative lubricating agents, preferably solid lubricating agents, include organic materials such as silicones, particularly dimethylsiloxane polymers, fatty acid amides such as ethylene bis (stearamides), oleamides and erucamide; and metal salts of fatty acids such as zinc, calcium, or lead stearates. Also suitable are inorganic materials such as talc, mica, fumed silica and calcium silicate. Particularly preferred are the fatty acid amides, oleamides, and erucamide. Quantities of lubricating agent of from about 0.01 to about 5% by weight based on the total weight of the mixture are satisfactory, more preferred are quantities of from about 0.05 to about 4% by weight.

The types of fire retardants include halogenated compounds, preferably brominated compounds, most preferably hexabromocycledodecane (HBCD), at loadings which typically yield halogen contents of about 0.5 to about 50 part per hundred resin (phr) in structures that are not foamed and about 0.05 to 20 phr in foamed structures . . . Synergistic combinations, such as mixtures of one or more halogenated compounds and one or more flame retardant synergists, may also be used, preferably at a ratio of 2-3 parts active halogen to 1 part flame retardant synergist.

The amount of flame retardant present within the composition of the present invention will depend upon the halogen content of the specific flame retardant used. Typically, the amount of flame retardant is chosen to yield halogen contents of about 0.5 to about 50 part per hundred resin (phr) in structures that are not foamed and about 0.05 to 20 phr in foamed structures. The preferred amounts depend on the application and the desired level of flame retardants. For structures that are not foamed, the halogen content in the final structures will typically be 0.5-50 wt %, preferably 1-40 wt % and most preferably 1.5-30 wt %. For foams, the halogen content in the final structures will be 0.05-20 wt %, preferably 0.1-15 wt % and most preferably 0.2-10 wt %.

The amount of flame retardant synergist present is typically present at a ratio of about 1 part synergist to about 3 parts of halogen in the flame retardant.

Applications for the flame resistant compositions of the present invention include, but are not limited to, articles made by calendering, injection molding, rotational molding, compression molding, extrusion, cast and blown film processes, or blow molding. Said articles are often in the form of a film, sheet, a multilayered structure, a floor, wall, or ceiling covering, foams, woven and non-woven fibers (including oriented fibers), electrical devices, wire and cable assemblies or tapes, including those used for insulation. Such articles may be used in automotive and other transportation devices, building and construction, household and garden appliances, power tool and appliance and electrical supply housing, and connectors, aircraft. The compositions are also useful in applications including hot melt and pressure sensitive adhesive systems, coatings (such as extrusion coating and spray coating in general), artificial leather, foam and film labels, house sidings, tarpaulins, geomembranes, thermal and acoustical insulation and pipes, sports and leisure goods, sound absorption and energy management systems. A particular embodiment of the current invention are the compositions in the form of foams

Preparation of Foams

Foam forming steps of the process are within the skill in the art. For instance as exemplified by the excellent teachings to processes for making ethylenic polymer foam structures and processing them in C. P. Park. “Polyolefin Foam”, Chapter 9, Handbook of Polymer Foams and Technology, edited by D. Klempner and K. C. Frisch, Hanser Publishers, Munich, Vienna, New York, Barcelona (1991), which is incorporated here in by reference. The foams may be crosslinked or substantially non-crosslinked and may take any physical configuration known in the art, such as extruded sheet, rod, plank and profiles. The foam structure also may be formed by molding expandable beads into any of the foregoing configurations or any other configuration.

The resulting foam structure is optionally made by a conventional extrusion foaming process. The structure is advantageously prepared by heating an ethylenic polymer material to form a plasticized or melt polymer material, incorporating therein a blowing agent to form a foamable gel, and extruding the gel through a die to form the foam product. Prior to mixing with the blowing agent, the polymer material is heated to a temperature at or above its glass transition temperature or melting point. The blowing agent is optionally incorporated or mixed into the melt polymer material by any means known in the art such as with an extruder, mixer, blender, or the like. The blowing agent is mixed with the melt polymer material at an elevated pressure sufficient to prevent substantial expansion of the melt polymer material and to advantageously disperse the blowing agent homogeneously therein. Optionally, a nucleator is optionally blended in the polymer melt or dry blended with the polymer material prior to plasticizing or melting. The foamable gel is typically cooled to a lower temperature to optimize physical characteristics of the foam structure. The gel is then extruded or conveyed through a die of desired shape to a zone of reduced or lower pressure to form the foam structure. The zone of lower pressure is at a pressure lower than that in which the foamable gel is maintained prior to extrusion through the die. The lower pressure is optionally superatmospheric or subatmospheric (vacuum), but is preferably at an atmospheric level.

In another embodiment, the resulting foam structure is optionally formed in a coalesced strand form by extrusion of the ethylenic polymer material through a multi-orifice die. The orifices are arranged so that contact between adjacent streams of the molten extrudate occurs during the foaming process and the contacting surfaces adhere to one another with sufficient adhesion to result in a unitary foam structure. The streams of molten extrudate exiting the die take the form of strands or profiles, which desirably foam, coalesce, and adhere to one another to form a unitary structure. Desirably, the coalesced individual strands or profiles should remain adhered in a unitary structure to prevent strand delamination under stresses encountered in preparing, shaping, and using the foam. Apparatuses and method for producing foam structures in coalesced strand form are seen in U.S. Pat. Nos. 3,573,152 and 4,824,720, both of which are incorporated herein by reference.

Alternatively, the resulting foam structure is conveniently formed by an accumulating extrusion process as seen in U.S. Pat. No. 4,323,528, which is incorporated by reference herein. In this process, low density foam structures having large lateral cross-sectional areas are prepared by: 1) forming under pressure a gel of the ethylenic polymer material and a blowing agent at a temperature at which the viscosity of the gel is sufficient to retain the blowing agent when the gel is allowed to expand; 2) extruding the gel into a holding zone maintained at a temperature and pressure which does not allow the gel to foam, the holding zone having an outlet die defining an orifice opening into a zone of lower pressure at which the gel foams, and an openable gate closing the die orifice; 3) periodically opening the gate; 4) substantially concurrently applying mechanical pressure by a movable ram on the gel to eject it from the holding zone through the die orifice into the zone of lower pressure, at a rate greater than that at which substantial foaming in the die orifice occurs and less than that at which substantial irregularities in cross-sectional area or shape occurs; and 5) permitting the ejected gel to expand unrestrained in at least one dimension to produce the foam structure.

In another embodiment, the resulting foam structure is formed into non-crosslinked foam beads suitable for molding into articles. To make the foam beads, discrete resin particles such as granulated resin pellets are: suspended in a liquid medium in which they are substantially insoluble such as water; impregnated with a blowing agent by introducing the blowing agent into the liquid medium at an elevated pressure and temperature in an autoclave or other pressure vessel; and rapidly discharged into the atmosphere or a region of reduced pressure to expand to form the foam beads. This process is well taught in U.S. Pat. Nos. 4,379,859 and 4,464,484, which are incorporated herein by reference.

One modification of the uncrosslinked bead process, styrene monomer is optionally impregnated into the suspended pellets prior to their impregnation with blowing agent to form a graft interpolymer with the ethylenic polymer material. The polyethylene/polystyrene interpolymer beads are cooled and discharged from the vessel substantially unexpanded. The beads are then expanded and molded by an expanded polystyrene bead molding process within the skill in the art. A process of making polyethylene/polystyrene interpolymer beads is described for instance in U.S. Pat. No. 4,168,353, which is incorporated herein by reference.

The foam beads are conveniently then molded by any means within the skill in the art, such as charging the foam beads to the mold, compressing the mold to compress the beads, and heating the beads such as with steam to effect coalescing and welding of the beads to form the article. Optionally, the beads are impregnated with air or other blowing agent at an elevated pressure and temperature prior to charging to the mold. Further, the beads are optionally heated prior to charging. The foam beads are conveniently then molded to blocks or shaped articles by a suitable molding method within the skill in the art such as taught for instance in U.S. Pat. Nos. 3,504,068 and 3,953,558. Excellent teachings of the above processes and molding methods are seen in C. P. Park, supra, p. 191, pp. 197-198, and pp. 227-229, which are incorporated herein by reference.

Blowing agents useful in making the resulting foam structure include inorganic agents, organic blowing agents and chemical blowing agents. Suitable inorganic blowing agents include carbon dioxide, nitrogen, argon, water, air, nitrogen, and helium. Organic blowing agents include aliphatic hydrocarbons having 1-6 carbon atoms, aliphatic alcohols having 1-3 carbon atoms, and fully and partially halogenated aliphatic hydrocarbons having 1-4 carbon atoms. Aliphatic hydrocarbons include methane, ethane, propane, n-butane, isobutane, n-pentane, isopentane, neopentane, and the like. Aliphatic alcohols include methanol, ethanol, n-propanol, and isopropanol. Fully and partially halogenated aliphatic hydrocarbons include fluorocarbons, chlorocarbons, and chlorofluorocarbons. Examples of fluorocarbons include methyl fluoride, perfluoromethane, ethyl fluoride, 1,1-difluoroethane (HFC-152a), 1,1,1-trifluoroethane (HFC-143a), 1,1,1,-2-tetrafluoro-ethane (HFC-134a), pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane. Partially halogenated chlorocarbons and chlorofluorocarbons for use in this invention include methyl chloride, methylene chloride, ethyl chloride, 1,1,1-trichloroethane, 1,1-dichloro-1 fluoroethane (HCFC-141b), 1-chloro 1,1-difluoroethane (HCFC-142b), 1-dichloro-2,2,2-trifluoroethane (HCFC-123) and 1-chloro-1, 2,2,2-tetrafluoroethane (HCFC-124). Fully halogenated chlorofluorocarbons include trichloromonofluoromethane (CFC-11), dichlorodifluoromethane (CFC-12), trichlorotrifluoroethane (CFC-113), 1,1,1-trifluoroethane, pentafluoroethane, dichlorotetrafluoroethane (CFC-114), chloroheptafluoropropane, and dichlorohexafluoropropane. Chemical blowing agents include azodicarbonamide, azodiisobutyro-nitrile, barium azodicarboxylate, n,n′-dimethyl-n,n′-dinitrosoterephthalamide, and benzenesulfonhydrazide, 4,4-oxybenzene sulfonyl semicarbazide, and p-toluene sulfonyl semicarbazide trihydrazino triazine. Preferred blowing agents include isobutane, HCFC-142b, HFC-152a, carbon dioxide and mixtures of the foregoing.

The amount of blowing agent incorporated into the polymer melt material to make a foam-forming polymer gel is typically from about 0.2 to about 5.0, preferably from about 0.5 to about 3.0, and most preferably from about 1.0 to 2.50 gram moles per kilogram of polymer. However, these ranges should not be taken to limit the scope of the present invention.

Foams are optionally perforated to enhance or accelerate permeation of blowing agent from the foam and air into the foam. The foams are optionally perforated to form channels which extend entirely through the foam from one surface to another or partially through the foam. The channels are advantageously spaced up to about 2.5 centimeters apart and preferably up to about 1.3 centimeters apart. The channels are advantageously present over substantially an entire surface of the foam and preferably are uniformly dispersed over the surface. The foams optionally employ a stability control agent of the type described above in combination with perforation to allow accelerated permeation or release of blowing agent while maintaining a dimensionally stable foam. Such perforation is within the skill in the art, for instance as taught in U.S. Pat. Nos. 5,424,016 and 5,585,058, which are incorporated herein by reference.

A stability control agent is optionally added to the present foam to enhance dimensional stability. Preferred agents include amides and esters of C10-24 fatty acids. Such agents are seen in U.S. Pat. Nos. 3,644,230 and 4,214,054, which are incorporated herein by reference. Most preferred agents include stearyl stearamide, glyceromonostearate, glycerol monobehenate, and sorbitol monostearate. Typically, such stability control agents are employed in an amount ranging from about 0.1 to about 10 parts per hundred parts of the polymer.

The resulting foam structure preferably exhibits excellent dimensional stability. Preferred foams recover 80 or more percent of initial volume within a month with initial volume being measured within 30 seconds after foam expansion. Volume is measured by a suitable method such as cubic displacement of water.

In addition, a nucleating agent is optionally added in order to control the size of foam cells. Preferred nucleating agents include inorganic substances such as calcium carbonate, talc, clay, titanium oxide, silica, barium sulfate, diatomaceous earth, mixtures of citric acid and sodium bicarbonate, and the like. The amount of nucleating agent employed may range from about 0.01 to about 5 parts by weight per hundred parts by weight of a polymer resin.

The resulting foam structure may be substantially noncrosslinked or uncrosslinked. The polymer material comprising the foam structure is substantially free of crosslinking. The foam structure contains no more than 30 percent gel as measured according to ASTM D-2765-84 Method A.

The foam structure may also be substantially cross-linked. Cross-linking may be induced by addition of a cross-linking agent or by radiation. Induction of cross-linking and exposure to an elevated temperature to effect foaming or expansion may occur simultaneously or sequentially. If a cross-linking agent is used, it is incorporated into the polymer material in the same manner as the chemical blowing agent. Further, if a cross-linking agent is used, the foamable melt polymer material is heated or exposed to a temperature of preferably less than 150° C. to prevent decomposition of the cross-linking agent or the blowing agent and to prevent premature cross-linking. If radiation cross-linking is used, the foamable melt polymer material is heated or exposed to a temperature of preferably less than 160° C. to prevent decomposition of the blowing agent. The foamable melt polymer material is extruded or conveyed through a die of desired shape to form a foamable structure. The foamable structure is then cross-linked and expanded at an elevated or high temperature (typically, 150° C.-250° C.) such as in an oven to form a foam structure. If radiation cross-linking is used, the foamable structure is irradiated to cross-link the polymer material, which is then expanded at the elevated temperature as described above. The present structure can advantageously be made in sheet or thin plank form according to the above process using either cross-linking agents or radiation.

The present foam structure may also be made into a continuous plank structure by an extrusion process utilizing a long-land die as described in GB 2,145,961A. In that process, the polymer, decomposable blowing agent and cross-linking agent are mixed in an extruder, heating the mixture to let the polymer cross-link and the blowing agent to decompose in a long-land die; and shaping and conducting away from the foam structure through the die with the foam structure and the die contact lubricated by a proper lubrication material.

The present foam structure may also be formed into cross-linked foam beads suitable for molding into articles. To make the foam beads, discrete resin particles such as granulated resin pellets are: suspended in a liquid medium in which they are substantially insoluble such as water; impregnated with a cross-linking agent and a blowing agent at an elevated pressure and temperature in an autoclave or other pressure vessel; and rapidly discharged into the atmosphere or a region of reduced pressure to expand to form the foam beads. A version is that the polymer beads is impregnated with blowing agent, cooled down, discharged from the vessel, and then expanded by heating or with steam. Blowing agent may be impregnated into the resin pellets while in suspension or, alternately, in non-hydrous state. The expandable beads are then expanded by heating with steam and molded by the conventional molding method for the expandable polystyrene foam beads.

The foam beads may then be molded by any means known in the art, such as charging the foam beads to the mold, compressing the mold to compress the beads, and heating the beads such as with steam to effect coalescing and welding of the beads to form the article. Optionally, the beads may be pre-heated with air or other blowing agent prior to charging to the mold. Excellent teachings of the above processes and molding methods are seen in C. P. Park, above publication, pp. 227-233, U.S. Pat. No. 3,886,100, U.S. Pat. No. 3,959,189, U.S. Pat. No. 4,168,353, and U.S. Pat. No. 4,429,059. The foam beads can also be prepared by preparing a mixture of polymer, cross-linking agent, and decomposable mixtures in a suitable mixing device or extruder and form the mixture into pellets, and heat the pellets to cross-link and expand.

In another process for making cross-linked foam beads suitable for molding into articles, the substantially random interpolymer material is melted and mixed with a physical blowing agent in a conventional foam extrusion apparatus to form an essentially continuous foam strand. The foam strand is granulated or pelletized to form foam beads. The foam beads are then cross-linked by radiation. The cross-linked foam beads may then be coalesced and molded to form various articles as described above for the other foam bead process. Additional teachings to this process are seen in U.S. Pat. No. 3,616,365 and C. P. Park, above publication, pp. 224-228.

The present foam structure may be made in bun stock form by two different processes. One process involves the use of a cross-linking agent and the other uses radiation.

The present foam structure may be made in bun stock form by mixing the substantially random interpolymer material, a cross-linking agent, and a chemical blowing agent to form a slab, heating the mixture in a mold so the cross-linking agent can cross-link the polymer material and the blowing agent can decompose, and expanding by release of pressure in the mold. Optionally, the bun stock formed upon release of pressure may be re-heated to effect further expansion.

Cross-linked polymer sheet may be made by either irradiating polymer sheet with high energy beam or by heating a polymer sheet containing chemical cross-linking agent. The cross-linked polymer sheet is cut into the desired shapes and impregnated with nitrogen in a higher pressure at a temperature above the softening point of the polymer; releasing the pressure effects nucleation of bubbles and some expansion in the sheet. The sheet is re-heated at a lower pressure above the softening point, and the pressure is then released to allow foam expansion.

The resulting foam structure may be either closed-celled or open-celled. The open cell content will range from 0 to 100 volume % as measured according to ASTM D2856-A.

Various additives are optionally incorporated in the resulting foam structure such as stability control agents, nucleating agents, inorganic fillers, pigments, antioxidants, acid scavengers, ultraviolet absorbers, flame retardants, processing aids, extrusion aids, and the like.

The resulting foam structure preferably has a density of less than 800, preferably less than 500, more preferably less than 250 and most preferably from about 10 to about 70 kilograms per cubic meter. The foams may be microcellular (i.e, with a cell size of from less than or equal to about 0.05 mm, preferably from about 0.001 to about 0.05 mm) or macrocellular (i.e., Cell size of about 0.05 mm or more). The cell sizes of the macrocellular foams will be from about 0.05 to about 15.0, preferably about 0.1 to about 10.0, and most preferably 0.2 to about 5 millimeters according to ASTM D3576. The preferred ranges of density and cell size should not be taken as limiting the scope of this invention.

### EXAMPLES

Test Methods

a) Melt Flow Measurements

The molecular weight of the polymer compositions for use in the present invention is conveniently indicated using a melt index measurement according to ASTM D-1238, Condition 190° C./2.16 kg (formally known as “Condition (E)” and also known as I₂) was determined. Melt index is inversely proportional to the molecular weight of the polymer. Thus, the higher the molecular weight, the lower the melt index, although the relationship is not linear.

b) Styrene Analyses

Interpolymer styrene content and atactic polystyrene concentration were determined using proton nuclear magnetic resonance (¹H N.M.R). All proton NMR samples were prepared in 1, 1, 2, 2-tetrachloroethane-d₂ (TCE-d₂). The resulting solutions were 1.6-3.2 percent polymer by weight. Melt index (I₂) was used as a guide for determining sample concentration. Thus when the I₂ was greater than 2, 40 mg of copolymer was used; with an I₂ between 1.5 and 2, 30 mg of copolymer was used; and when the I₂ was less than 1.5, 20 mg of copolymer was used. The polymers were weighed directly into 5 mm sample tubes. A 0.75 mL aliquot of TCE-d₂ was added by syringe and the tube was capped with a tight-fitting polyethylene cap. The samples were heated in a water bath at 85° C. to soften the polymer. To provide mixing, the capped samples were occasionally brought to reflux using a heat gun.

Proton NMR spectra were accumulated on a Varian VXR 300 with the sample probe at 80° C., and referenced to the residual protons of TCE-d₂ at 5.99 ppm. The delay times were varied between 1 second, and data was collected in triplicate on each sample. The following instrumental conditions were used for analysis of the interpolymer samples:

Varian VXR-300, standard ¹H:

Sweep Width, 5000 Hz

Acquisition Time, 3.002 sec

Pulse Width, 8 μsec

Frequency, 300 MHz

Delay, 1 sec

Transients, 16

The total analysis time per sample was about 10 minutes.

Initially, a ¹H NMR spectrum for a sample of the polystyrene, Styron™ 680 (available form the Dow Chemical Company, Midland, Mich.) was acquired with a delay time of one second. The protons were “labeled”: b, branch; a, alpha; o, ortho; m, meta; p, para, as shown in FIG. 1)

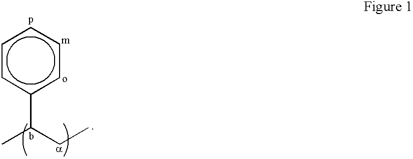

Integrals were measured around the protons labeled in FIG. 1; the ‘A’ designates aPS. Integral A_{7.1} (aromatic, around 7.1 ppm) is believed to be the three ortho/para protons; and integral A_{6.6} (aromatic, around 6.6 ppm) the two meta protons. The two aliphatic protons labeled a resonate at 1.5 ppm; and the single proton labeled b is at 1.9 ppm. The aliphatic region was integrated from about 0.8 to 2.5 ppm and is referred to as Aₐₗ. The theoretical ratio for A_{7.1}:A_{6.6}:Aₐₗ is 3:2:3, or 1.5:1:1.5, and correlated very well with the observed ratios for the Styron™ 680 sample for several delay times of 1 second. The ratio calculations used to check the integration and verify peak assignments were performed by dividing the appropriate integral by the integral A_{6.6} Ratio Aᵣ is A_{7.1}/A_{6.6}.

Region A_{6.6} was assigned the value of 1. Ratio Al is integral Aₐₗ/A_{6.6}. All spectra collected have the expected 1.5:1:1.5 integration ratio of (o+p):m:(α+b). The ratio of aromatic to aliphatic protons is 5 to 3. An aliphatic ratio of 2 to 1 is predicted based on the protons labeled α and b respectively in FIG. 1. This ratio was also observed when the two aliphatic peaks were integrated separately.

For the ethylene/styrene interpolymers, the ¹H NMR spectra using a delay time of one second, had integrals C_{7.1}, C_{6.6}, and Cₐₗ defined, such that the integration of the peak at 7.1 ppm included all the aromatic protons of the copolymer as well as the o & p protons of aPS. Likewise, integration of the aliphatic region Cₐₗ in the spectrum of the interpolymers included aliphatic protons from both the aPS and the interpolymer with no clear baseline resolved signal from either polymer. The integral of the peak at 6.6 ppm C_{6.6} is resolved from the other aromatic signals and it is believed to be due solely to the aPS homopolymer (probably the meta protons). (The peak assignment for atactic polystyrene at 6.6 ppm (integral A_{6.6}) was made based upon comparison to the authentic sample Styron™ 680.) This is a reasonable assumption since, at very low levels of atactic polystyrene, only a very weak signal is observed here. Therefore, the phenyl protons of the copolymer must not contribute to this signal. With this assumption, integral A_{6.6} becomes the basis for quantitatively determining the aPS content.

The following equations were then used to determine the degree of styrene incorporation in the ethylene/styrene interpolymer samples:

(C Phenyl)=C_{7.1}+A_{7.1}−(1.5×A_{6.6})

(C Aliphatic)=Cₐₗ−(15×A_{6.6})

S_{c}=(C Phenyl)/5

e_{c}=(C Aliphatic−(3×s_{c}))/4

E=e_{c}/(e_{c}+s_{c})

S_{c}=S_{c}/(e_{c}+S_{c})

and the following equations were used to calculate the mol % ethylene and styrene in the interpolymers.

$$Wt \% E = \frac{E * 28}{( E * 28 ) + ( {S}_{c} * 104 )} ( 100 )$$

$$\text{and}$$

$$Wt \% S = \frac{{S}_{c} * 104}{( E * 28 ) + ( {S}_{c} * 104 )} ( 100 )$$

where: s_{c} and e_{c} are styrene and ethylene proton fractions in the interpolymer, respectively, and S_{c} and E are mole fractions of styrene monomer and ethylene monomer in the interpolymer, respectively.

The weight percent of aPS in the interpolymers was then determined by the following equation:

$$Wt \% aPS = \frac{( Wt \% S ) * ( \frac{\frac{{A}_{6.6}}{2}}{{s}_{c}} )}{100 + [ ( Wt \% S ) * ( \frac{\frac{{A}_{6.6}}{2}}{{s}_{c}} ) ]} * 100$$

The total styrene content was also determined by quantitative Fourier Transform Infrared spectroscopy (FTIR).

### EXAMPLES

The following examples are to illustrate this invention and do not limit it. Ratios, parts, and percentages are by weight unless otherwise stated.

Polymerizations

Ethylene Styrene interpolymers (ESI) #'s 1-3 were prepared in a continuously operating loop reactor (36.8 gal, 0.14 m³). An Ingersoll-Dresser twin screw pump provided the mixing. The reactor ran liquid full at 475 psig (3,275 kPa) with a residence time of approximately 25 minutes. Raw materials and catalyst/cocatalyst flows were fed into the suction of the twin screw pump through injectors and Kenics static mixers. The twin screw pump discharged into a 2″ diameter line which supplied two Chemineer-Kenics 10-68 Type BEM Multi-Tube heat exchangers in series. The tubes of these exchangers contained twisted tapes to increase heat transfer. Upon exiting the last exchanger, loop flow returned through the injectors and static mixers to the suction of the pump. Heat transfer oil was circulated through the exchangers' jacket to control the loop temperature probe located just prior to the first exchanger. The exit stream of the loop reactor was taken off between the two exchangers. The flow and solution density of the exit stream was measured by a MicroMotion.

Solvent feed to the reactor was supplied by two different sources. A fresh stream of toluene from an 8480-S-E Pulsafeeder diaphragm pump with rates measured by a MicroMotion flowmeter was used to provide flush flow for the reactor seals (20 lb/hr (9.1 kg/hr). Recycle solvent was mixed with uninhibited styrene monomer on the suction side of five 8480-5-E Pulsafeeder diaphragm pumps in parallel. These five Pulsafeeder pumps supplied solvent and styrene to the reactor at 650 psig (4,583 kPa). Fresh styrene flow was measured by a MicroMotion flowmeter, and total recycle solvent/styrene flow was measured by a separate MicroMotion flowmeter. Ethylene was supplied to the reactor at 687 psig (4,838 kPa). The ethylene stream was measured by a Micro-Motion mass flowmeter. A Brooks flowmeter/controller was used to deliver hydrogen into the ethylene stream at the outlet of the ethylene control valve. The ethylene/hydrogen mixture combined with the solvent/styrene stream at ambient temperature. The temperature of the entire feed stream as it entered the reactor loop was lowered to 2° C. by an exchanger with −10° C. glycol on the jacket. Preparation of the three catalyst components took place in three separate tanks: fresh solvent and concentrated catalyst/cocatalyst premix were added and mixed into their respective run tanks and fed into the reactor via variable speed 680-S-AEN7 Pulsafeeder diaphragm pumps. As previously explained, the three component catalyst system entered the reactor loop through an injector and static mixer into the suction side of the twin screw pump. The raw material feed stream was also fed into the reactor loop through an injector and static mixer downstream of the catalyst injection point but upstream of the twin screw pump suction.

Polymerization was stopped with the addition of catalyst kill (water mixed with solvent) into the reactor product line after the MicroMotion flowmeter measuring the solution density. A static mixer in the line provided dispersion of the catalyst kill and additives in the reactor effluent stream. This stream next entered post reactor heaters that provided additional energy for the solvent removal flash. This flash occurred as the effluent exited the post reactor heater and the pressure was dropped from 475 psig (3,275 kPa) down to 450 mmHg (60 kPa) of absolute pressure at the reactor pressure control valve. This flashed polymer entered the first of two hot oil jacketed devolatilizers. The volatiles flashing from the first devolatizer were condensed with a glycol jacketed exchanger, passed through the suction of a vacuum pump, and were discharged to the solvent and styrene/ethylene separation vessel. Solvent and styrene were removed from the bottom of this vessel as recycle solvent while ethylene exhausted from the top. The ethylene stream was measured with a MicroMotion mass flowmeter. The measurement of vented ethylene plus a calculation of the dissolved gases in the solvent/styrene stream were used to calculate the ethylene conversion. The polymer and remaining solvent separated in the devolatilizer was pumped with a gear pump to a second devolatizer. The pressure in the second devolatizer was operated at 5 mmHg (0.7 kPa) absolute pressure to flash the remaining solvent. This solvent was condensed in a glycol heat exchanger, pumped through another vacuum pump, and exported to a waste tank for disposal. The dry polymer (<1000 ppm total volatiles) was pumped with a gear pump to an underwater pelletizer with 6-hole die, pelletized, spin-dried, and collected in 1000 lb boxes.

The following were the properties of the ESI resins used to prepare the blend compositions of the present invention (Table 1):

TABLE 1

| | styrene | Atactic | melt index |
|---|---|---|---|
| Sample | (wt %) | polystyrene (%) | (dg/min) |
| ESI 1 | 69.5 | 8.9 | 0.94 |
| ESI 2 | 69 | — | 1 |
| ESI 3 | 30 | — | 1 |

### Examples 1-5

Foams Made with HBCD as Fire-Retardant

A foaming process comprising a single-screw extruder, mixer, coolers and die was used to make foam planks. Carbon dioxide (CO₂) was used as the blowing agent at a level of 4.7 phr, to foam polystyrene and a blend of polystyrene with ESI. The other additives are as shown in Table 2. The foaming temperature was 123° C. The data in Table 2 show that the LOI values of the foams of the present invention were greater than 23% oxygen and that the foams retained the desired physical and mechanical properties.

TABLE 2

| | Ex 1 | Ex 2 | Ex 3 | Ex 4 | Ex 5 |
|---|---|---|---|---|---|
| Polymers (wt %) | | | | | |
| PS XZ94007.40 | 95 | | | | |
| PS 680 | | 80 | 80 | 80 | 80 |
| ESI 1 | 5 | 20 | 20 | 20 | 20 |
| Foaming Temperature (° C.) | 123 | 121 | 119 | 117 | 125 |
| Additives (phr) | | | | | |
| CO2 | 4.7 | | 4.7 | 4.7 | 4.23 |
| HCFC-142b | | 13 | | | |
| HFC-134a | | | | | 1.1 |
| LLDPE | 0.4 | 0.4 | 0.4 | 0.4 | |
| Properties | | | | | |
| Density with skin (kg/m3) : 30D | 40.9 | 33.8 | 40.2 | 42.7 | 45.3 |
| Density without skin (kg/m3): 30D | 39.1 | 32.0 | 37.4 | 40.4 | 41.4 |
| 3D avg. cell size (mm) | 0.34 | 0.26 | 0.30 | 0.30 | 0.29 |
| Open cells (vol. %) | 18.8 | 9.4 | 89.8 | 78.3 | 92.7 |
| LOI (% O2) | 29.7 | 28.4 | 26.4 | 26.6 | 28.3 |
| Bromine (%) | 1.70 | 1.74 | 1.67 | 1.82 | 1.64 |
| Com. str. (kPa) : 30D : vertical | 421 | 257 | 203 | 245 | 174 |
| Extrusion | 287 | 113 | 168 | 234 | 158 |
| Horizontal | 216 | 184 | 149 | 172 | 167 |
| Total | 924 | 554 | 520 | 651 | 499 |
| Vertical/total | 0.46 | 0.46 | 0.39 | 0.38 | 0.35 |
| total/(kg/m3)ˆ 2 | 0.60 | 0.54 | 0.37 | 0.40 | 0.29 |
| Com. mod. (kPa): 30D : vertical | 18886 | 13282 | 17093 | 17367 | 11648 |
| Extrusion | 8126 | 3127 | 4390 | 6059 | 3750 |
| Horizontal | 6887 | 5903 | 5013 | 5476 | 5527 |
| Total | 33899 | 22312 | 26496 | 28902 | 20925 |
| Thermal conductivity (mW/m K) at 10° C. :30D | 33.4 | 28.3 | 35.0 | 34.4 | 33.8 |
| WD max. at 30D (%) | 1.92 | 0.44 | 2.54 | 2.70 | 2.75 |
| Environmental Dimensional Change, EDC, asap (max. change) | −0.2 | 2.4 | −0.3 | −0.3 | -0.3 |
| Environmental Dimensional Change, EDC, at 30D (max. change) | −0.2 | 5.2 | −1.0 | −1.0 | -0.8 |
| Heat Distortion Temperature, HDT, ASAP (° C.) | 94 | | 91 | 91 | 94 |
| Heat Distortion Temperature, HDT, at 30D (° C.) | >97 | | | 88 | 91 |
| Water pickup | 0.96 | 0.60 | 1.48 | 1.10 | 2.72 |

*All examples contained 2.5 phr HBCD, 0.2 phr Barium Steararte, 0.15 phr Blue, and 0.2 phr TSPP. “D” refers to days.

### Examples 6-25

ESI and ESI blends with brominated fire-retardant (FR) with and without anti mony trioxide

ESI and ESI/PE blends containing various amounts of brominated FR were first dry blended and then melt blended in a Haake mixer at 16520 C. and 30 rpm for a total about 10 minutes. ESI/PP blends were compounded in a Hakke mixer at 18520 C. and 30 rpm for about 10 minutes. The LOI values and UL-94 ratings for the various formulations are shown in Table 3.

These examples (in Table 3) demonstrate that foams made from blends of PS and ESI with HBCD as the flame retardant, show acceptable flame resistance (i.e. LOI>23%) while retaining physical and mechanical properties. These data also demonstrate that acceptable LOI values can be achieved with HBCD in the absence of a synergist such as antimony trioxide. shows the LOI of PP/ES69 blends is similar to those of the pure components. It can also be seen that HBCD yields a higher LOI than Saytex (102)

TABLE 3

| | ESI 2 | ESI 3 | PF814 | KC8852 | Saytex | HBCD | Sb₂O₃ | LOI | UL94 T1 | UL94 T2 |
|---|---|---|---|---|---|---|---|---|---|---|
| Ex | wt % | wt % | PP wt % | wt % PE | 102E wt % | wt % | wt % | % O₂ | sec | sec |
| 6 | 87.7 | | | | 9.6 | | 2.7 | 32.5 | 1.1 | 0.8 |
| 7 | 81.5 | | | | 14.5 | | 4 | 33.9 | 0.9 | 0.8 |
| 8 | 75.4 | | | | 19.3 | | 5.3 | 34.4 | 0.8 | 0.8 |
| 9 | 75.9 | | | | 24.1 | | | 31.0 | 39.7 | 26.2 |
| 10 | 80 | | | | | 16 | 4 | 41.2 | 0.8 | 0.8 |
| 11 | 73.4 | | | | | 21.3 | 5.3 | 42.3 | 0.8 | 0.8 |
| 12 | | | 81.5 | | 14.5 | | 4 | 31.7 | 2.1 | 2.5 |
| 13 | 20.4 | | 61.1 | | 14.5 | | 4 | 31.6 | 6.6 | 34.8 |
| 14 | 40.7 | | 40.8 | | 14.5 | | 4 | 32.5 | 4.6 | 1 |
| 15 | 61.1 | | 20.4 | | 14.5 | | 4 | 32.5 | 0.8 | 0.8 |
| 16 | 18.9 | | 56.5 | | 19.3 | | 5.3 | 33.1 | 19.9 | 6 |
| 17 | | 20.4 | 61.1 | | 14.5 | | 4 | 34.0 | 3.2 | 1.5 |
| 18 | 20 | | 60 | | | 16 | 4 | 39.1 | 0.8 | 0.9 |
| 19 | 18.4 | | 55 | | | 21.3 | 5.3 | 38.3 | 0.9 | 1 |
| 20 | | | | 81.5 | 14.5 | | 4 | 35.3 | 1.1 | 0.7 |
| 21 | 20.4 | | | 61.1 | 14.5 | | 4 | 34.3 | 0.9 | 0.7 |
| 22 | 18.9 | | | 56.5 | 19.3 | | 5.3 | 36.1 | 1.1 | 0.8 |
| 23 | 81 | | | | 19 | | | 33.0 | 3 | 30 |
| 24 | 84 | | | | | 16 | | 36.8 | 0.9 | 0.8 |
| 25 | 79 | | | | | 21 | | 39.1 | 0.9 | 0.8 |

| | | | | | | | | Calc | UL94 | UL94 |
|---|---|---|---|---|---|---|---|---|---|---|
| | ESI 2 | ESI 3 | PF814 | KC8852 | Saytex | HBCD | Sb₂O₃ | density | drip | category |
| Ex # | g | g | PP g | PE g | 102E g | g | g | g/cm³ | flame | V0,1,2 |
| 6 | 168.4 | | | | 18.4 | | 5.2 | 1.0550 | * | V0 |
| 7 | 164.6 | | | | 29.3 | | 8.1 | 1.1103 | * | V0 |
| 8 | 160.6 | | | | 41.1 | | 11.3 | 1.1708 | | V0 |
| 9 | 159.4 | | | | 50.6 | | | 1.1564 | | fail |
| 10 | 160.0 | | | | | 32.0 | 8.0 | 1.1011 | | V0 |
| 11 | 154.1 | | | | | 44.7 | 11.1 | 1.1572 | | V0 |
| 12 | | | 154.8 | | 27.6 | | 7.6 | 1.0447 | *yes | V2 |
| 13 | 39.2 | | 117.3 | | 27.8 | | 7.7 | 1.0604 | yes | fail |
| 14 | 79.4 | | 79.6 | | 28.3 | | 7.8 | 1.0765 | yes | V2 |
| 15 | 121.0 | | 40.4 | | 28.7 | | 7.9 | 1.0931 | * | V0 |
| 16 | 38.4 | | 114.7 | | 39.2 | | 10.8 | 1.1193 | yes | fail |
| 17 | | 39.2 | 117.3 | | 27.8 | | 7.7 | 1.0553 | yes* | V2 |
| 18 | 38.2 | | 114.6 | | | | 7.6 | 1.0528 | * | V0 |
| 19 | 37.0 | | 110.6 | | | | 10.6 | 1.1082 | * | V0 |
| 20 | | | | 150.8 | 26.8 | | 7.4 | 1.0172 | * | V0 |
| 21 | 38.6 | | | 115.5 | 27.4 | | 7.6 | 1.0390 | * | V0 |
| 22 | 37.6 | | | 112.4 | 38.4 | | 10.5 | 1.0973 | * | V0 |
| 23 | 162.8 | | | | 38.2 | | | 1.1084 | yes | fail |
| 24 | 162.1 | | | | | 30.9 | | 1.0607 | * | V0 |
| 25 | 157.2 | | | | | 41.8 | | 1.0966 | * | V0 |

*while burner is under specimen material drips into/onto burner

The examples in Table 3 include compositions of ESI alone at both high and low styrene levels, in addition to blends of ESI at both high and low styrene levels with polyethylene and polypropylene. The data demonstrate that acceptable LOI values can be accomplished using a variety of halogenated flame retardants. The data also demonstrate that higher LOI values are obtained with HBCD v. Saytex. The data also demonstrate that with both HBCD v. Saytex, the addition of SbO₃ results in a synergistic effect and a further increase in LOI.

We claim:

1. A flame retardant composition comprising;
(A) a polymer composition comprising
1) from about 0.5 to 100 percent by weight (based on the combined weight of Components 1 and 2) of one or more substantially random interpolymers comprising;
a) from about 0.5 to about 65 mol % of polymer units derived from;
(i) at least one vinyl or vinylidene aromatic monomer, or
(ii) at least one hindered aliphatic or cycloaliphatic vinyl or vinylidene monomer, or
(iii) a combination of at least one aromatic vinyl or vinylidene monomer and at least one hindered aliphatic or cycloaliphatic vinyl or vinylidene monomer, and
(b) from about 35 to about 99.5 mol % of polymer units derived from at least one of ethylene and/or a C₃₋₂₀ α-olefin; and
(c) from 0 to about 20 mol % of polymer units derived from one or more of ethylenically unsaturated polymerizable monomers other than those derived from (a) and (b); and;
(2) from 0 to about 99.5 percent by weight (based on the combined weight of Components 1 and 2) of one or more thermoplastics other than Component 1; and
(B) one or more halogenated flame retardants or a combination of one or more halogenated flame retardants and any other non-halogenated flame retardants, said halogenated flame retardants present in an amount sufficient to give a halogen content in said flame retardant composition of from about 0.5 to about 50 weight percent based on the combined weights of Components A and B; and optionally
(C) one or more flame retardant synergists present in an amount sufficient to give a ratio of 1 part by weight synergist to about 3 parts by weight of halogen present in said halogenated flame retardant,
and wherein the limiting oxygen index (LOI) of said flame retardant composition is greater than about 21% oxygen.

2. The flame retardant composition of claim 1 comprising;
(A) a polymer composition comprising
1) from about 1 to 100 percent by weight (based on the combined weight of Components 1 and 2) of one or more substantially random interpolymers comprising;
a) from about 1 to about 55 mol % of polymer units derived from;
(i) said vinyl or vinylidene aromatic monomer represented by the following formula; 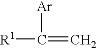
wherein R¹ is selected from the group of radicals consisting of hydrogen and alkyl radicals containing three carbons or less, and Ar is a phenyl group or a phenyl group substituted with from 1 to 5 substituents selected from the group consisting of halo, C₁₋₄-alkyl, and C₁₋₄-haloalkyl; or
(ii) said sterically hindered aliphatic or cycloaliphatic vinyl or vinylidene monomer is represented by the following general formula; 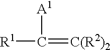
wherein A¹ is a sterically bulky, aliphatic or cycloaliphatic substituent of up to 20 carbons, R¹ is selected from the group of radicals consisting of hydrogen and alkyl radicals containing from 1 to about 4 carbon atoms, preferably hydrogen or methyl; each R² is independently selected from the group of radicals consisting of hydrogen and alkyl radicals containing from 1 to about 4 carbon atoms, preferably hydrogen or methyl; or alternatively R¹ and A¹ together form a ring system; or
iii) a combination of i and ii;
(b) from about 45 to about 99 mol % of polymer units derived from ethylene and/or said α-olefin which comprises at least one of propylene, 4-methyl-1-pentene, butene-1, hexene-1 or octene-1; and
(c) said ethylenically unsaturated polymerizable monomers other than those derived from (a) and (b) comprises norbornene, or a C₁₋₁₀ alkyl or C₆₋₁₀ aryl substituted norbornene;
2) from 0 to about 99 percent by weight (based on the combined weight of Components 1 and 2) of one or more thermoplastics other than Component 1 comprising one or more of the α-olefin homopolymers and interpolymers, the thermoplastic olefins (TPOs), the styrene-diene copolymers, the styrenic copolymers, the elastomers, the thermoset polymers, the vinyl halide polymers, and the engineering thermoplastics; and
(B) one or more halogenated flame retardants comprising hexahalodiphenyl ethers, octahalodiphenyl ethers, decahalodiphenyl ethers, decahalobiphenyl ethanes, 1,2-bis(trihalophenoxy)ethanes, 1,2-bis(pentahalophenoxy)ethanes, hexahalocyclododecane, a tetrahalobisphenol-A, ethylene(N, N′)-bis-tetrahalo-phthalimides, tetrahalophthalic anhydrides, hexahalobenzenes, halogenated indanes, halogenated phosphate esters, halogenated paraffins, halogenated polystyrenes, and polymers of halogenated bisphenol-A and epichlorohydrin, or mixtures thereof or combination of said halogenated flame retardants with one or more phosphorous containing non-halogenated flame retardants and wherein said halogenated flame retardants are present in an amount sufficient to give a halogen content in said flame retardant composition of from about 1.0 to about 40 weight percent based on the combined weights of Components A and B; and optionally
(C) one or more flame retardant synergists comprising metal oxides, boron compounds, antimony silicates, zinc stannate, zinc hydroxystannate, ferrocene dicumyl and polycumyl, and mixtures thereof, and present in an amount sufficient to give a ratio of 1 part by weight synergist to about 2 parts by weight of halogen present in said halogenated flame retardant,
and wherein the limiting oxygen index (LOI) of said flame retardant composition is greater than about 23% oxygen.

3. The flame retardant composition of claim 1 comprising;
(A) a polymer composition comprising
1) from about 2 to 100 percent by weight (based on the combined weight of Components 1 and 2) of one or more substantially random interpolymers comprising;
a) from about 1 to about 50 mol % of polymer units derived from;
(i) said vinyl aromatic monomer which comprises styrene, α-methyl styrene, ortho-, meta-, and para-methylstyrene, and the ring halogenated styrenes, or
(ii) said aliphatic or cycloaliphatic vinyl or vinylidene monomers which comprises 5-ethylidene-2-norbornene or 1-vinylcyclo-hexene, 3-vinylcyclo-hexene, and 4-vinylcyclohexene; or
(iii) a combination of a and b; and
b) from about 50 to about 99 mol % of polymer units derived from ethylene, or ethylene and said α-olefin, which comprises ethylene, or ethylene and at least one of propylene, 4-methyl-1-pentene, butene-1, hexene-1 or octene-1; and
c) said ethylenically unsaturated polymerizable monomers other than those derived from (a) and (b) is norbornene; and;
2) from 0 to about 98 percent by weight (based on the combined weight of Components 1 and 2) of one or more thermoplastics other than Component 1; and
(B) said halogenated flame retardants comprise one or more hexahalocyclododecanes and present in an amount sufficient to give a halogen content in said flame retardant composition of from about 1.5 to about 30 weight percent based on the combined weights of Components A and B.

4. The flame retardant composition of claim 3 wherein Component (A) is a substantially random interpolymer of ethylene and styrene and Component is B is hexabromocyclododecane or a combination of hexabromocyclododecane and triphenylphosphate or encapsulated red phosphorous.

5. The flame retardant composition of claim 3 wherein Component (A) is a substantially random interpolymer of ethylene, propylene and styrene and Component is B is hexabromocyclododecane or a combination of hexabromocyclododecane and triphenylphosphate or encapsulated red phosphorous.

6. A foam comprising;
(A) a polymer composition comprising
1) from about 0.5 to 100 percent by weight (based on the combined weight of Components 1 and 2) of one or more substantially random interpolymers comprising;
a) from about 0.5 to about 65 mol % of polymer units derived from;
(i) at least one vinyl or vinylidene aromatic monomer, or
(ii) at least one hindered aliphatic or cycloaliphatic vinyl or vinylidene monomer, or
(iii) a combination of at least one aromatic vinyl or vinylidene monomer and at least one hindered aliphatic or cycloaliphatic vinyl or vinylidene monomer, and
(b) from about 35 to about 99.5 mol % of polymer units derived from at least one of ethylene and/or a C₃₋₂₀ α-olefin; and
(c) from 0 to about 20 mol % of polymer units derived from one or more of ethylenically unsaturated polymerizable monomers other than those derived from (a) and (b); and;
(2) from 0 to about 99.5 percent by weight (based on the combined weight of Components 1 and 2) of one or more thermoplastics other than Component 1; and
(B) one or more halogenated flame retardants or a combination of one or more halogenated flame retardants and any other non-halogenated flame retardants, said halogenated flame retardants present in an amount sufficient to give a halogen content in said flame retardant composition of from about 0.05 to about 20 weight percent based on the combined weights of Components A and B; and optionally
(C) one or more flame retardant synergists present in an amount sufficient to give a ratio of 1 part by weight synergist to about 3 parts by weight of halogen present in said halogenated flame retardant,
and wherein the limiting oxygen index (LOI) of said flame retardant composition is greater than about 21% oxygen.

7. The foam of claim 6 comprising;
(A) a polymer composition comprising
1) from about 1 to 100 percent by weight (based on the combined weight of Components 1 and 2) of one or more substantially random interpolymers comprising;
a) from about 1 to about 55 mol % of polymer units derived from;
(i) said vinyl or vinylidene aromatic monomer represented by the following formula; 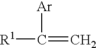
wherein R¹ is selected from the group of radicals consisting of hydrogen and alkyl radicals containing three carbons or less, and Ar is a phenyl group or a phenyl group substituted with from 1 to 5 substituents selected from the group consisting of halo, C₁₋₄-alkyl, and C₁₋₄-haloalkyl; or
(ii) said sterically hindered aliphatic or cycloaliphatic vinyl or vinylidene monomer is represented by the following general formula; 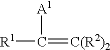
wherein A¹ is a sterically bulky, aliphatic or cycloaliphatic substituent of up to 20 carbons, R¹ is selected from the group of radicals consisting of hydrogen and alkyl radicals containing from 1 to about 4 carbon atoms, preferably hydrogen or methyl; each R² is independently selected from the group of radicals consisting of hydrogen and alkyl radicals containing from 1 to about 4 carbon atoms, preferably hydrogen or methyl; or alternatively R¹ and A¹ together form a ring system; or
iii) a combination of i and ii;
(b) from about 45 to about 99 mol % of polymer units derived from ethylene and/or said α-olefin which comprises at least one of propylene, 4-methyl-1-pentene, butene-1, hexene-1 or octene-1; and
(c) said ethylenically unsaturated polymerizable monomers other than those derived from (a) and (b) comprises norbornene, or a C₁₋₁₀ alkyl or C₆₋₁₀ aryl substituted norbornene;
2) from 0 to about 99 percent by weight (based on the combined weight of Components 1 and 2) of one or more thermoplastics other than Component 1 comprising one or more of the α-olefin homopolymers and interpolymers, the thermoplastic olefins (TPOs), the styrene-diene copolymers, the styrenic copolymers, the elastomers, the thermoset polymers, the vinyl halide polymers, and the engineering thermoplastics; and
(B) one or more halogenated flame retardants comprising hexahalodiphenyl ethers, octahalodiphenyl ethers, decahalodiphenyl ethers, decahalobiphenyl ethanes, 1,2-bis(trihalophenoxy)ethanes, 1,2-bis(pentahalophenoxy)ethanes, hexahalocyclododecane, a tetrahalobisphenol-A, ethylene(N, N′)-bis-tetrahalo-phthalimides, tetrahalophthalic anhydrides, hexahalobenzenes, halogenated indanes, halogenated phosphate esters, halogenated paraffins, halogenated polystyrenes, and polymers of halogenated bisphenol-A and epichlorohydrin, or mixtures thereof or combination of said halogenated flame retardants with one or more phosphorous containing non-halogenated flame retardants and wherein said halogenated flame retardants are present in an amount sufficient to give a halogen content in said flame retardant composition of from about 0.1 to about 15 weight percent based on the combined weights of Components A and B; and optionally
(C) one or more flame retardant synergists comprising metal oxides, boron compounds, antimony silicates, zinc stannate, zinc hydroxystannate, ferrocene dicumyl and polycumyl, and mixtures thereof, and present in an amount sufficient to give a ratio of 1 part by weight synergist to about 2 parts by weight of halogen present in said halogenated flame retardant,
and wherein the limiting oxygen index (LOT) of said flame retardant composition is greater than about 23% oxygen.

8. The foam of claim 6 comprising;
A) a polymer composition comprising
1) from about 2 to 100 percent by weight (based on the combined weight of Components 1 and 2) of one or more substantially random interpolymers comprising;
a) from about 1 to about 50 mol % of polymer units derived from;
(i) said vinyl aromatic monomer which comprises styrene, (α-methyl styrene, ortho-, meta-, and para-methylstyrene, and the ring halogenated styrenes, or
(ii) said aliphatic or cycloaliphatic vinyl or vinylidene monomers which comprises 5-ethylidene-2-norbornene or 1-vinylcyclo-hexene, 3-vinylcyclo-hexene, and 4-vinylcyclohexene; or
(iii) a combination of a and b; and
b) from about 50 to about 99 mol % of polymer units derived from ethylene, or ethylene and said α-olefin, which comprises ethylene, or ethylene and at least one of propylene, 4-methyl-1-pentene, butene-1, hexene-1 or octene-1; and
c) said ethylenically unsaturated polymerizable monomers other than those derived from (a) and (b) is norbornene; and;
2) from 0 to about 98 percent by weight (based on the combined weight of Components 1 and 2) of one or more thermoplastics other than Component 1; and
B) said halogenated flame retardants comprise one or more hexahalocyclododecanes and present in an amount sufficient to give a halogen content in said flame retardant composition of from about 0.2 to about 10 weight percent based on the combined weights of Components A and B.

9. The foam of claim 8 wherein Component (A) is a substantially random interpolymer of ethylene and styrene and Component is B is hexabromocyclododecane or a combination of hexabromocyclododecane and triphenylphosphate or encapsulated red phosphorous.

10. The foam of claim 8 wherein Component (A) is a substantially random interpolymer of of ethylene, propylene and styrene and Component is B is hexabromocyclododecane or a combination of hexabromocyclododecane and triphenylphosphate or encapsulated red phosphorous.

11. The foam of claim 6, having a density less than about 800 kilograms per cubic meter (kg/m³) and a cell size of less than or equal to 0.05 millimeters.

12. The foam of claim 6, having a density from about 10 to about 70 kilograms per cubic meter (kg/m³) and a cell size from about 0.001 to about 0.05 millimeters.

13. The foam of claim 6, having a density less than about 800 kilograms per cubic meter (kg/m³) and a cell size of about 0.05 to about 15 millimeters.

14. The foam of claim 6, having a density of less than about 500 kg/m³ and a cell size of about 0.1 to about 10 millimeters.

15. The foam of claim 6, having a density from about 10 to about 70 kg/m³ and a cell size of about 0.2 to about 5 millimeters.
